(19) United States
(12) Patent Application Publication
(10) Pub. No.: US 2024/0095540 A1
(43) Pub. Date: Mar. 21, 2024

(54) REDUCING DATA COMMUNICATIONS IN DISTRIBUTED INFERENCE SCHEMES

(71) Applicant: Western Digital Technologies, Inc., San Jose, CA (US)

(72) Inventors: Minghai QIN, Milpitas, CA (US); Jaco HOFMANN, Santa Clara, CA (US); Chao SUN, San Jose, CA (US); Qingbo WANG, Irvine, CA (US); Dejan VUCINIC, San Jose, CA (US)

(73) Assignee: Western Digital Technologies, Inc., San Jose, CA (US)

(21) Appl. No.: 18/343,173

(22) Filed: Jun. 28, 2023

Related U.S. Application Data
(60) Provisional application No. 63/406,412, filed on Sep. 14, 2022.

(51) Int. Cl. G06N 3/098

(52) U.S. Cl. CPC G06N 3/098

(57) ABSTRACT

Methods and apparatus for processing data in a distributed inference scheme based on sparse inputs. An example method includes receiving an input at a first node. A first sparsified input is generated for a second node based on a set of features associated with the second node, which are identified based on a weight mask having non-zero values for weights associated with features upon which processing by the second node depends and zeroed values for weights associated with other features. The first sparsified input is transmitted to the second node for generating an output of the second node. A second sparsified input is received from the second node and combined into a combined input. The combined input is processed into an output of the first node. The neural network is configured to generate an inference based on processing the outputs of the first node and the second node.

### CROSS-REFERENCE TO RELATED APPLICATIONS

This application claims benefit of U.S. Provisional Patent Application Ser. No. 63/406,412, entitled “DISCO: Distributed Inference with Sparse Communications,” filed Sep. 14, 2022, and assigned to the assignee hereof, the entire contents of which are herein incorporated by reference.

### BACKGROUND OF THE DISCLOSURE

### Field of the Disclosure

Embodiments of the present disclosure generally relate to neural networks, and more specifically to reducing communications overheads in neural networks executing in distributed inference schemes.

### Description of the Related Art

Various machine learning architectures have been used to provide solutions for a wide variety of computational problems. An assortment of machine learning model architectures exist, such as artificial neural networks (which may include convolutional neural networks (CNNs), recurrent neural networks (RNNs), deep neural networks, generative adversarial networks (GANs), and the like), random forest models, and the like. Increasingly, transformer neural networks have been widely used in a variety of image and video processing tasks, or other tasks in which multidimensional data is processed in order to generate various inferences related to the multidimensional data.

Training and inferencing using neural networks is generally a computationally expensive process in terms of processing cycles and memory utilization metrics. The computational demands, however, vary. In training, throughput, or the rate at which a model processes samples over time, may be a performance metric for which various optimizations are targeted. In inferencing, however, latency, or the difference between the time at which a data sample is input into a model and the time at which an inference is generated, may significantly impact the performance of various applications, such as time-sensitive applications like autonomous driving, tele-surgery, and the like.

### SUMMARY OF THE DISCLOSURE

The present disclosure generally provides techniques for reducing the communications overhead involved in distributed inferencing schemes by sparsifying the data transmitted between nodes participating in a distributed inferencing scheme. Generally, sparse data from one node may be merged with data at other nodes participating in the distributed inferencing scheme in order to allow for an inference to be generated based on sparse data from some nodes and data from other nodes participating in the distributed inference scheme.

Certain embodiments provide a node participating in a distributed inferencing scheme. The node generally includes a memory having executable instructions stored thereon and a processor configured to execute the executable instructions. When the executable instructions are executed by the processor, the node receives an input for processing by a neural network executing on a plurality of nodes participating in the distributed inference scheme. A first sparsified input is generated for a second node based on a set of features associated with the second node. Generally, the set of features associated with the second node are identified based on a weight mask having non-zero values associated with weights for features upon which processing by the second node depends and zeroed values associated with weights for features other than the features upon which processing by the second node depends. The first sparsified input is transmitted to the second node. A second sparsified input is received from the second node and combined with the received input into a combined input, and the combined input is processed into an output of the first node. The neural network may be configured to generate an inference based on processing the output of the first node and the output of the second node and output the generated inference.

Certain embodiments provide a method for inferencing in a distributed inferencing scheme. An example method generally includes receiving an input for processing by a neural network executing on a plurality of nodes participating in the distributed inference scheme. A first sparsified input is generated for a second node based on a set of features associated with the second node. Generally, the set of features associated with the second node are identified based on a weight mask having non-zero values for weights associated with features upon which processing by the second node depends and zeroed values for weights associated with features other than the features upon which processing by the second node depends. The first sparsified input is transmitted to the second node. A second sparsified input is received from the second node and combined with the received input into a combined input. The combined input is processed into an output of the first node. The neural network may be configured to generate an inference based on processing the output of the first node and the output of the second node and output the generated inference.

Certain embodiments provide a method for training a neural network to generate inferences based on sparse input data generated by nodes participating in a distributed inference scheme. An example method generally includes training a neural network including a plurality of layers; generating a respective weight mask matrix for each respective layer of the plurality of layers in the neural network based on a number of input features and a number of output features in the respective layer and calculated vector norms for non-diagonal rows in the respective weight mask matrix; and deploying the neural network and the respective weight mask matrix for each respective layer of the plurality of layers.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 illustrates an example environment including processing nodes participating in a distributed inference scheme, according to embodiments of the present disclosure.

FIG. 2 illustrates an example of processing input data by nodes participating in a distributed inference scheme, according to embodiments of the present disclosure.

FIG. 3 illustrates an example of generating output feature maps at nodes participating in a distributed inference scheme based on sparse feature maps transferred between the nodes, according to embodiments of the present disclosure.

FIG. 4 illustrates an example of a result generated based on sparse data and a masked weight matrix in a distributed inference scheme, according to embodiments of the present disclosure.

FIG. 5 illustrates example operations for inferencing based on sparse data in a distributed inference scheme, according to embodiments of the present disclosure.

FIG. 6 illustrates example operations for training a neural network to generate inferences based on sparse data in a distributed inference scheme, according to embodiments of the present disclosure.

FIG. 7 illustrates an example system on which embodiments of the present disclosure can be performed.

FIG. 8 illustrates an example system on which embodiments of the present disclosure can be performed.

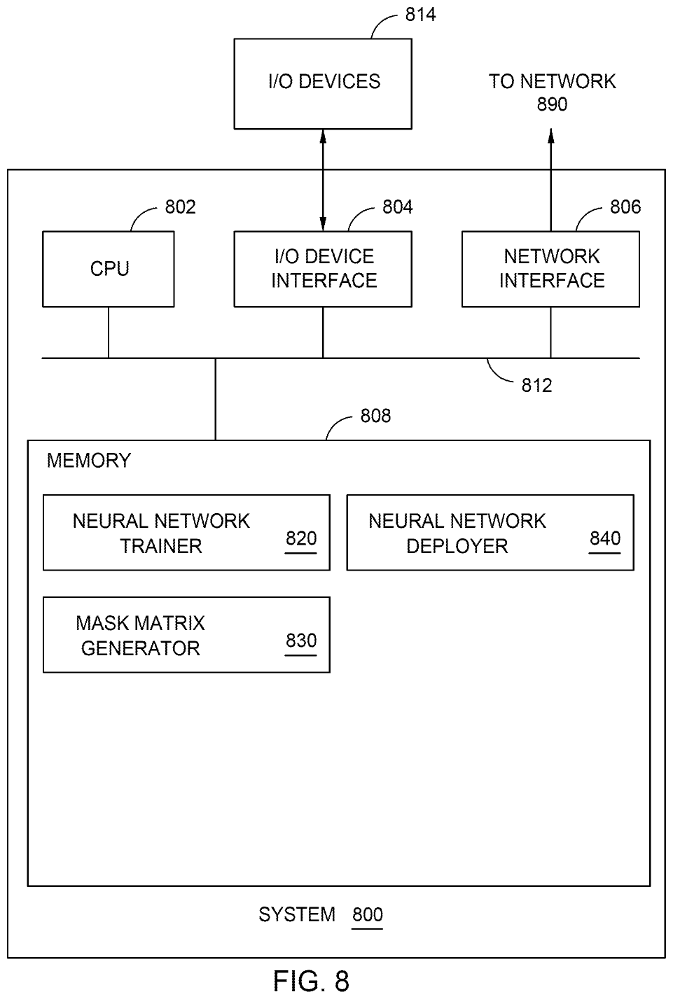

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

In the following, reference is made to embodiments of the disclosure. However, it should be understood that the disclosure is not limited to specifically described embodiments. Instead, any combination of the following features and elements, whether related to different embodiments or not, is contemplated to implement and practice the disclosure. Furthermore, although embodiments of the disclosure may achieve advantages over other possible solutions and/or over the prior art, whether or not a particular advantage is achieved by a given embodiment is not limiting of the disclosure. Thus, the following aspects, features, embodiments, and advantages are merely illustrative and are not considered elements or limitations of the appended claims except where explicitly recited in a claim(s). Likewise, reference to “the disclosure” shall not be construed as a generalization of any inventive subject matter disclosed herein and shall not be considered to be an element or limitation of the appended claims except where explicitly recited in a claim(s).

Deep neural networks are trained and deployed to perform various operations, such as natural language processing, video analysis, data compression, and the like. Generally, training and inferencing using deep neural networks is a computationally expensive process due to the amount of data generated and processed using a deep neural network. Further, the computational expense may, in some cases, scale non-linearly as the size of the input data increases.

To allow for inferencing to be performed efficiently while minimizing, or at least reducing, the computational expense incurred by a computing device, inferencing operations performed using deep neural networks may be distributed such that different systems, or nodes, participating in a distributed inference scheme can generate inferences in parallel. For example, in a distributed inference scheme, different nodes may be configured to process data at different stages (e.g., layers) of a neural network. A first node may process input data through a first layer of the neural network, a second node may process the output of the first layer of the neural network, a third node may process the output of the second layer of the neural network, and so on.

However, the communications overhead involved in a distributed inference scheme may impose significant latencies which may be problematic for applications that rely on real-time, or at least near-real-time, inferencing, such as autonomous driving, remote surgery, robotics, or other applications in which inference outputs are used to allow for actions to be taken in real-time within the environment in which inferencing is performed. For example, in a deep neural network deployed in a distributed inference scheme, an inference may be based on the multiplication of input features and weights defined for the neural network. For a given set of I input features and N nodes, computation within the distributed inference scheme may be distributed across I/N nodes. At each node, an output feature may be generated based on some features provided as input features to other nodes in the distributed inference scheme; however, in the distributed inference scheme, nodes generally transmit the entire input to other nodes for processing. In doing so, communications latency may be increased, even though the receiving node(s) may not use all of the data transmitted from another node in an inference.

To minimize the computational overhead involved in a distributed inference scheme, thus, a node can select a subset of input features and share these input features with other nodes in the distributed inference scheme. However, selecting the features to be provided to each node participating in the distributed inference scheme is a computationally infeasible task. For a number of features I_{each} associated with each node participating in a distributed inference scheme and a number of features I_{comm} communicated from an i^{th} node to a j^{th} node, there are

$$( \begin{matrix}{I}_{e a c h} \\ {I}_{c o m m}\end{matrix} )$$

possible subsets of input features that can be selected, and choosing a set of features is an NP-hard problem.

However, since operations in a deep neural network typically involve multiplication, and because the product of 0 and any number is 0, it is zeroing an input feature and multiplying that input feature by a weight in a deep neural network is mathematically equivalent to multiplying that input feature by a zeroed weight value. To reduce the communications overhead involved in generating inferences in a distributed inference scheme, aspects of the present disclosure leverage this equivalence to convert a feature selection problem to a weight pruning problem and using information about pruned weights to identify features to be shared between nodes in a neural network. By using information about pruned weights to identify features to communicate between different nodes participating in a distributed inference scheme, aspects of the present disclosure may reduce the amount of data transferred between nodes relative to transmitting the entirety of an input feature set from one node to another for use in inferencing operations, which may reduce communications latency in a distributed inference scheme and allow for nodes to generate inferences on input data while complying with latency targets for applications based on real-time, or at least near-real-time, inferencing.

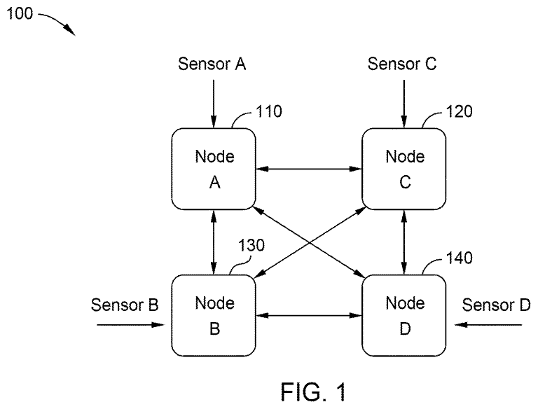

FIG. 1 illustrates an example environment 100 including processing nodes participating in a distributed inference scheme, according to embodiments of the present disclosure.

As illustrated, environment 100 includes nodes 110, 120, 130, and 140, which may represent different computing devices communicatively coupled to each other (e.g., via a network, such as a local area network, a wide area network, a local bus, etc.). Each of nodes 110, 120, 130, and 140 may include one or more general-purpose processors or special-purpose processors and may ingest data from one or more sensors for use in generating inferences on data captured within environment 100. For example, nodes 110, 120, 130, and 140 may correspond to computing units associated with different sensors in an autonomous driving scenario, computing units associated with Internet of Things (IoT) devices communicatively coupled in a wide area network and used for various environmental sensing tasks, or the like.

Generally, each of nodes 110, 120, 130, and 140 (and other nodes not illustrated in FIG. 1) may ingest data about a portion of the environment 100 in which these nodes are deployed. However, an inference that reflects the state of environment 100 may not be accurately generated based on data local to one of nodes 110, 120, 130, or 140 alone. Thus, in order to generate an accurate inference, nodes 110, 120, 130, and 140 may communicate with each other in order to allow for at least one of the nodes to generate an inference based on the combination of data from each of nodes 110, 120, 130, and 140 (and other nodes), which may provide information about the environment 100 in its entirety.

To minimize the communications overhead involved in communicating input features or other input data between nodes 110, 120, 130, and 140 in environment 100, a subset of features may be communicated between each pair of nodes in the environment 100. To identify the features to be communicated between different nodes in the environment 100, a deep neural network may be trained to perform a specific inferencing task based on data captured or otherwise ingested by nodes in the environment 100 and participating in a distributed inference scheme. This neural network may be, for example, a convolutional neural network, a transformer neural network, or other neural network for which inferencing can be parallelized in a distributed inference scheme.

The trained neural network generally includes a plurality of layers (e.g., convolutional layers) that perform various computations within the neural network. For example, the trained neural network may include an input layer that ingests an input for which an inference is to be generated, one or more intermediate layers which perform various computations within the neural network, and an output layer that uses the results of these computations to generate an output representative of the ingested input. It should be noted that different layers of the neural network may depend or otherwise use different pieces of data as input features from which an output is generated; that is, in order to generate an output, a neural network may not depend on some data captured or otherwise ingested by different nodes in the environment 100. Thus, to reduce the communications overhead involved in a distributed inference scheme, these unneeded input features may not be transmitted between different nodes in the environment 100.

As discussed above, while feature selection may be a computationally intractable problem, feature selection problem may be converted to a weight pruning problem. Generally, weights within a neural network may indicate an importance assigned within the neural network, or at least within different layers of the neural network, to various input features or data derived therefrom. Features associated with large weights may thus have a significant impact on the output generated by the neural network, and features associated with smaller weights may have a less significant impact on the output generated by the neural network.

Thus, in training the neural network deployed to nodes 110, 120, 130, and 140 in the environment 100, a pruning pattern may be defined as a weight mask matrix for a specific node. This weight mask matrix may be a sequence of convolutional kernels corresponding to input features in other nodes in the environment 100. For example, in an example in which a four-dimensional weight matrix is projected into a two-dimensional mask matrix by condensing each convolutional kernel into a single value representing whether the kernel includes only 0 values. The resulting weight mask matrix (and pruning pattern) generally includes

$$\frac{1}{N}$$

non-zeroed rows, as each row in the weight mask matrix represents weights that are pertinent to mathematical operations within other nodes in the environment 100 that participate in a distributed inference scheme.

Within the weight mask matrix, the features corresponding to the specific node for which the weight mask matrix is generated may always be unmasked (e.g., not zeroed out). Thus, the weight mask matrix may leave diagonal blocks unmasked (or at least substantially unmasked), and the opposing anti-diagonal blocks may be masked (or at least substantially masked) based on whether features associated with specific weights are relevant or not relevant to an output generated by a neural network for a given input at a given node on which the neural network executes.

Generally, the weight mask matrix may be represented by the expression M∈{0,1}^{I×O}, where I corresponds to the number of input features, O corresponds to the number of output features, and the weight mask matrix is generated for each kernel in the neural network. For each sub-row having a size of 1 row by O/N columns corresponding to OWH/N weights in the neural network, a statistical norm may be calculated. This statistical norm may be, for example, the L1 norm, or the sum of the absolute values within each sub-row. To identify the sub-rows to be pruned (e.g., masked using the weight mask matrix), the x rows with the lowest calculated statistical norms may be masked. Generally x may be selected based on the desired sparsity in the weight mask matrix, which corresponds to the desired communication sparsity for a given layer in the neural network. The features associated with unmasked weights may be considered the features that have the most significance to calculations within a given layer of the neural network and should be communicated between nodes in environment 100 that participate in a distributed inference scheme. As discussed above, by using a weight mask matrix to identify features that are relevant and features that are less relevant to generating an output at a node in environment 100, aspects of the present disclosure can select a subset of the input features to transmit to other nodes in the environment 100, which may reduce communication latencies and other resource utilization involved in communicating information between nodes participating in a distributed inference scheme.

At inference time, as discussed in further detail below, each node 110, 120, 130, and 140 captures sensor data or otherwise ingests data based on which an inference about environment 100 may be generated. Using the weight mask matrices generated for the neural network, each node 110, 120, 130, and 140 may generate a sparsified set of features to communicate to other nodes in the environment 100 and may combine a sparsified set of features from the other nodes with input features associated with the captured or otherwise ingested data into a combined input. The combined input may be processed using the neural network to generate an inference for the combined input, which may be acted upon (e.g., to cause a node to perform a specific action within the environment 100) or may be communicated used as an input into another layer of the neural network for further processing.

In some aspects, nodes 110, 120, 130, and 140 (and other nodes participating in a distributed inference scheme) can process input data in a pipelined manner. For example, assume that inputs 1 through 4 are received at node 110 sequentially and are to be processed by nodes 110, 120, 130, and 140 sequentially (e.g., such that the output of node 110 is the input to node 120, the output of node 120 is the input to node 130, and so on). After node 110 processes input 1, the output of node 110 for input 1 is provided as input to node 120. While node 120 is processing input 1 (or data derived therefrom), node 110 can process input 2. Likewise, after node 110 processes input 2 and node 120 processes input 1, node 110 can process input 3, node 120 can process input 2 (or data derived therefrom), and node 130 can process input 1 (or data derived therefrom). By performing inferences in a pipelined manner, aspects of the present disclosure may reduce latency in a distributed inferencing system, as some portions of data may be processed at a node while waiting for data from other nodes participating in the distributed inference scheme.

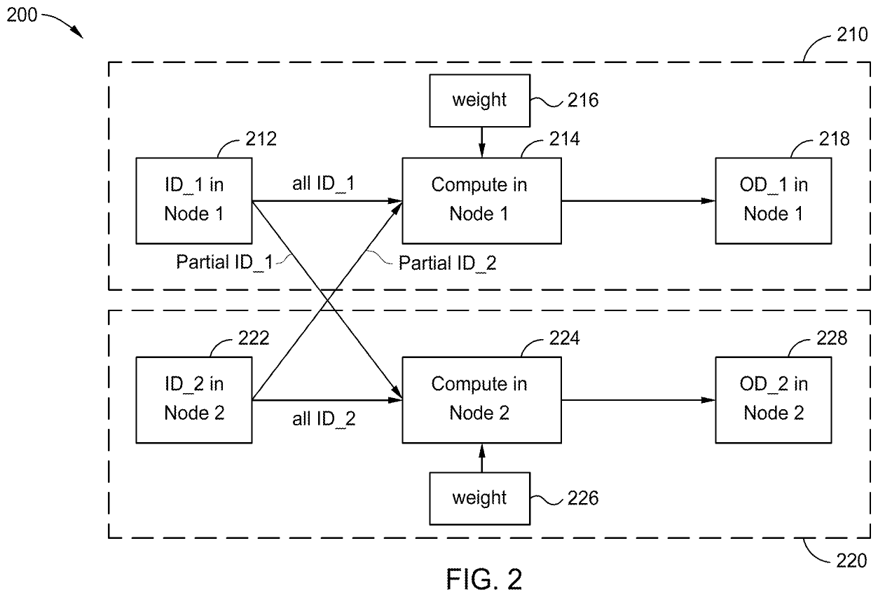

FIG. 2 illustrates an example 200 of processing input data by nodes participating in a distributed inference scheme, according to embodiments of the present disclosure. While example 200 illustrates inferencing distributed across two nodes, node 210 and node 220, it should be recognized that any number of nodes can participate in a distributed inference scheme.

Generally, operations at node 210 and node 220 may operate in parallel, or at least substantially in parallel. At node 210, first input data 212 may be sparsified into a partial, or sparsified, version of the first input data. This sparsified version of the first input data may be provided to node 220 for use in performing various computations on a combination of second input data 222 captured by node 220 and the sparsified version of the first input data. Similarly, a sparsified version of the second input data may be provided by node 220 to node 210. Node 210 can combine the first input data 212 and the sparsified version of the second input data into a combined input, which may be combined with weight data 216 in computation block 214. The output 218 of computation block 214 may be a first output which may be provided as an input into another layer of a neural network or treated as an inference based on which various actions can be performed within the environment in which nodes 210 and 220 are deployed.

Likewise, at computation block 224, node 220 combines the second input data and the sparsified version of the first input data into a combined input. This combined input may be combined with weights 226 at computation block 224 to generate a second output 228. Like the output 218 discussed above, the output 228 generated by node 220 may be provided as an input into another layer of the neural network or treated as another inference based on which various actions can be performed within the environment in which nodes 210 and 220 are deployed.

Because nodes 210 and 220 exchange sparsified versions of their respective input data, communications latency in a distributed inference scheme in which these nodes participate may be reduced relative to schemes in which nodes 210 and 220 exchange non-sparsified versions of their respective input data. Assume that a neural network has a computational complexity of C_{c} (e.g., measured in terms of a number of operations per second, such as a number of floating point operations per second (FLOPS)) and a total input feature size of Fₛ in bytes, with inferencing distributed over N nodes. In a distributed inference scheme in which participating nodes exchange non-sparsified versions of their respective input data, each node (e.g., node 210 and node 220 illustrated in FIG. 2) may transmit N bytes of data to each of the other participating nodes and may receive

$$\frac{( N - 1 ) {F}_{s}}{N}$$

bytes of data from the other participating nodes in the distributed inference scheme. Thus, the total communications overhead for each node may be Fₛ bytes of data, even though, as discussed above, inferencing for a layer of a neural network executed by any given node may not rely on all of the data ingested by the participating nodes.

For a given level of communication sparsity S_{comm} defined for each node participating in a distributed inference scheme and reflected in the weight mask matrix defined for each node and a given bandwidth B within a network in which participating nodes communicate, the communications latency for a sparsified input may be defined according to the expression:

$${L}_{c o m m} = \frac{{F}_{s} ( 1 - {S}_{c o m m} )}{B}$$

Meanwhile, the computation sparsity of the entire layer, given a computation speed C for a node, may be defined according to the expression:

$${L}_{c o m p} = \frac{{C}_{c} ( 1 - {S}_{c o m p} )}{N C}$$

It may be seen that L_{comm} is significantly larger than L_{comp}. Generally, L_{comm} may be at least an order of magnitude larger than L_{comp}, and these relationships generally hold across computing platforms with different computational capabilities. Thus, by minimizing, or at least reducing, communications latency involved in a distributed inference scheme by reducing the amount of data communicated between nodes participating in a distributed inference scheme, aspects of the present disclosure may significantly improve inference performance by minimizing idle time between the computation of computations by a node for a first data set and the receipt of a second data set on which an inference is to be performed.

Further reductions in computational complexity may be achieved due to the reduction in the inputs communicated between different nodes participating in the distributed inference scheme. For example, when a layer of a neural network is distributed evenly across N nodes, the convolutional kernel in each node may be a four-dimensional tensor with dimensions

$$( W , H , I , \frac{O}{N} ) ,$$

where, as discussed above, W and H represent the dimensions of the kernel, I represents the number of input features, O represents the number of output features, and N represents the number of participating nodes in the distributed inference scheme. For a sparsified number of input features I′, the reduction in communications, or the communication sparsity, may be represented by the expression:

$${S}_{c o m m} = \frac{NI - I - {I}^{′} N}{( N - 1 ) I}$$

Meanwhile, because a node has a total of

$$\frac{1}{N} + {I}^{′}$$

features as an input, with a resulting shape of a convolutional kernel having dimensions of

$$( W , H , \frac{1}{N} + {I}^{′} , \frac{O}{N} ) ,$$

the reduction in computational expense, or the computational sparsity, may be represented by the equation:

$${S}_{c o m m} = \frac{NI - I - {I}^{′} N}{NI}$$

Thus, the total latency involved in a distributed inference scheme based on sparsified inputs may be represented by the equation:

$${S}_{c o m m} = \frac{N}{N - 1} {S}_{c o m p}$$

The latency of a layer of a neural network distributed across nodes participating in a distributed inference scheme may be determined by the slower of L_{comm} and L_{comp}. Because both L_{comm} and L_{comp} may be reduced by increasing S_{comm}, it may be inferred that there exists some equilibrium point S_{comm}^{eql} at which L_{comm}=L_{comp}. If S_{comm}<S_{comm}^{eql}, reductions in L_{comm} may reduce the total latency in the distributed inference system. If, however, S_{comm}>S_{comm}^{eql}, reductions in L_{comm} achieved by further increasing the sparsity of input features communicated by nodes participating in the distributed inference scheme may contribute to a reduction in inference accuracy that is not outweighed by the reduction in latency within the distributed inference scheme.

In some aspects, the equilibrium point may differ for different layers of a neural network. Thus earlier layers (e.g., layers closer to an input layer) in the neural network may be configured to support higher levels of sparsity, while later layers (e.g., layers closer to an output layer) in the neural network may be configured to support lower levels of sparsity such that increasing amounts of data are exchanged between nodes participating in the distributed inference scheme as processing approaches the output layer of the neural network.

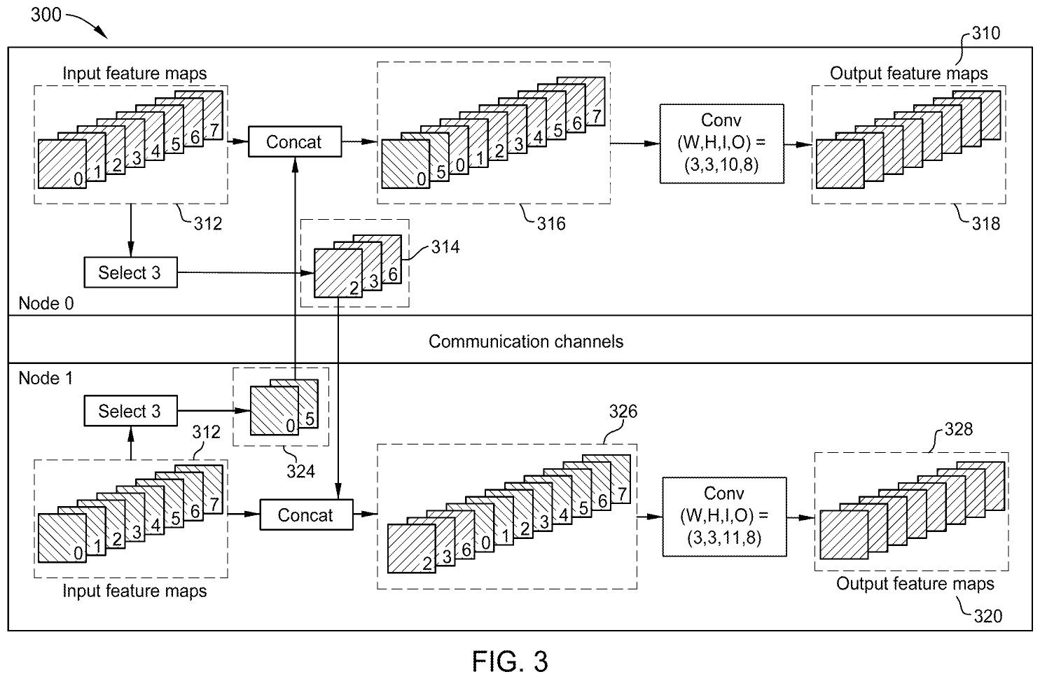

FIG. 3 illustrates an example 300 of generating output feature maps at nodes participating in a distributed inference scheme based on sparse feature maps transferred between the nodes, according to embodiments of the present disclosure. While example 300 illustrates an example in which two nodes, nodes 310 and 320, participate in a distributed inference scheme it should be recognized that any number of nodes can participate in a distributed inference scheme and share features between each other in order to generate inferences based on data from multiple participating nodes in the distributed inference scheme.

As illustrated, the first node 310 receives as input a first set of feature maps 312, indexed 0 through 7 (and referred to herein as feature maps 312₀ through 312₇). Similarly, the second node 320 receives as input a second set of feature maps 322, also indexed 0 through 7 (and referred to herein as feature maps 322₀ through 322₇). These sets of feature maps 312 and 322 may be received, for example, from other nodes participating in a distributed inference scheme. To allow for nodes 310 and 320 to generate output feature maps and perform inferences on data from both nodes participating in example 300, nodes 310 and 320 may select respective subsets 314 and 324 of input feature maps to communicate to the other node so that each node 310 and 320 can generate output feature maps 318 and 328 (and/or inferences therefrom) based on a combination of feature maps from nodes 310 and 320.

As illustrated, based on a weight mask generated for the nodes 310 and 320 (discussed above), node 310 may select a subset 314 of feature maps 312. Subset 314 may include feature maps 312₂, 312₃, and 312₆. Meanwhile, node 320 may select a subset 324 of feature maps 322, including feature maps 322₀ and 322₅. The subset 314 generated by node 310 may be transmitted to node 320, which generates a combined set of feature maps 326 including feature maps 312₂, 312₃, 312₆, and 322₀ through 322₇. Similarly, the subset 324 generated by node 320 may be transmitted to node 310, which generates a combined set of feature maps 316 including feature maps 312₀ through 312₇, 322₀, and 322₅. Node 310 may perform a convolution operation on the combined set of feature maps 316 to generate output feature maps 318, and node 320 may perform a convolution operation on the combined set of feature maps 326 to generate output feature maps 328. The output feature maps 318, 328 may be shared with one or more participating nodes in the distributed inference scheme in order for the other participating nodes in the distributed inference scheme to add additional information and/or generate a final inference based on feature maps generated from data shared between the participating nodes in the distributed inferencing scheme.

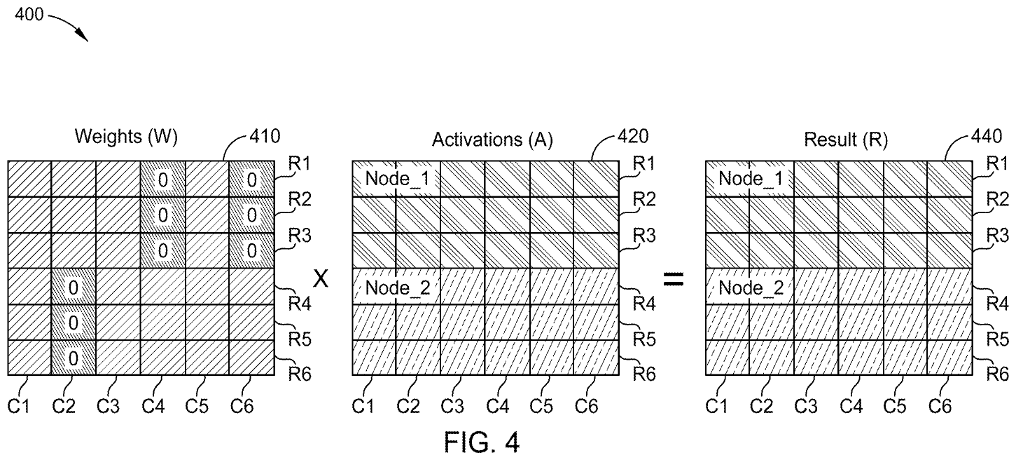

FIG. 4 illustrates an example 400 of a result generated based on sparse data and a masked weight matrix in a distributed inference scheme, according to embodiments of the present disclosure.

As discussed, a result 430 generated within a layer of a neural network may be represented as the product of a weight matrix 410 and activations matrix 420 associated with an input into the layer of the neural network. The result 430, as illustrated, may be a combination of results generated by a first node participating in a distributed inference scheme (rows 0 through 2 of result 430) and results generated by a second node participating in the distributed inference scheme (rows 3 through 5 of result 430). In this example, there may be six input features which are used to generate result 430, divided into a first set of (three) features associated with the first node and second set of (three) features associated with the second node. The first set of features corresponds to rows 0 through 2 in activations matrix 420, and the second set of features corresponds to rows 3 through 5 in activations matrix 420.

The weights in weight matrix 410 may be used to identify which features are pertinent to computations performed by each node participating in the distributed inference scheme. Generally, features may be transferred to a node when such features are associated with non-zero weights in weight matrix 410, and features may not be transferred to a node when such features are associated with zero-valued weights in weight matrix 410. Within weight matrix 410, each column may represent a mask applied to a corresponding input in activations matrix 420, with the first three rows of weight matrix 410 corresponding to a weight mask matrix for the first node and the second three rows of weight matrix 410 corresponding to a weight mask matrix for the second node. Based on properties of matrix multiplication, it may be noted, thus, that the results generated by the first node do not depend on input features at rows 3 and 5 in activations matrix 420, as the corresponding columns 3 and 5 in weight matrix 410 have zero-valued weights. Similarly, it may be noted that the results generated by the second node do not depend on input features at row 1 in activations matrix 420, as the corresponding column 1 in weight matrix 310 have zero-valued weights.

Based on this observation, thus, the first node may transfer features associated with rows 0 and 2 in the activation matrix 420 to the second node and need not transfer features associated with row 1 in the activation matrix 420 to the second node. Meanwhile, the second node may transfer features associated with row 4 in the activation matrix 420 to the first node and need not transfer features associated with rows 3 and 5 in the activation matrix 420 to the first node. Thus, relative to non-sparsified communications in which all 6 input features are transferred, only 3 features may be transferred between nodes in example 400, representing a 50 percent reduction in communications overhead within an environment in which nodes participating in a distributed inference scheme participate.

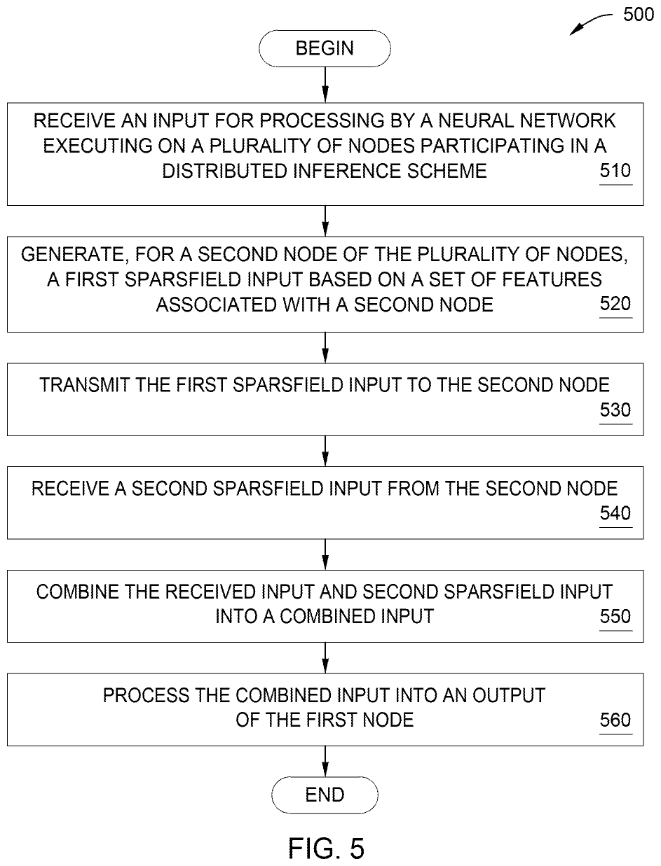

FIG. 5 illustrates example operations 500 for inferencing based on sparse data in a distributed inference scheme, according to embodiments of the present disclosure. Operations 500 may be performed by a node participating in a distributed inference scheme, such as nodes 110, 120, 130, or 140 illustrated in FIG. 1, nodes 210 or 220 illustrated in FIG. 2, and/or nodes 310 or 320 illustrated in FIG. 3.

As illustrated, operations 500 begin at block 510 with receiving an input for processing by a neural network executing on a plurality of nodes participating in the distributed inference scheme. The neural network may include, for example, a convolutional neural network, a transformer neural network, or other neural networks which can be distributed across different nodes participating in the distributed inference scheme. For a convolutional neural network, the input may include a feature map representing data to be processed using the convolutional neural network. For a transformer neural network, the input may include one or more neuron vectors representing data to be processed using the transformer neural network (e.g., vectors corresponding to queries, keys, and attention outputs in the transformer neural network)

At block 520, operations 500 proceed with generating, for a second node of the plurality of nodes, a first sparsified input based on a set of features associated with the second node. Generally, the set of features associated with the second node are identified based on a weight mask having non-zero values for weights associated with features upon which processing by the second node depends and zeroed values for weights associated with features other than the features upon which processing by the second node depends.

In some aspects, the set of features associated with the second node of the plurality of nodes is selected further based on a level of communication sparsity defined for the neural network. Generally, the number of features included in the set of features associated with the second node may have an inverse relationship to the level of communication sparsity defined for the neural network. That is, larger numbers of features may be associated with the second node as the level of communication sparsity decreases, and smaller numbers of features may be associated with the second node as the level of communication sparsity increases.

In some aspects, the weight mask comprises a two-dimensional matrix including information identifying weights for each kernel of a plurality of kernels in the neural network, wherein kernels associated with the features upon which processing by the second node depends are associated with non-zero values in the two-dimensional matrix and kernels associated with features other than the features upon which processing by the second node depends are associated with zeroed values in the two-dimensional matrix. Diagonal blocks in the two-dimensional matrix generally include non-zero values associated with features used by the neural network for inputs associated with the node.

In some aspects, the number of features associated with the second node is based, at least in part, on a number of nodes participating in the distributed inference scheme. For example, a neural network may be configured to evenly distribute computation across nodes participating in the distributed inference scheme. For a number N of nodes participating in the distributed inference scheme, the number of features associated with any node may be.

In some aspects, the set of features associated with the second node of the plurality of nodes comprises features having a statistical norm that is less than a threshold value. The threshold value, as discussed, may be defined based on a defined level of communication sparsity for the neural network.

At block 430, operations 400 proceed with transmitting the first sparsified input to the second node.

At block 440, operations 400 proceed with receiving a second sparsified input from the second node.

At block 450, operations 400 proceed with combining the received input and the second sparsified input into a combined input.

At block 460, operations 400 proceed with processing the combined input into an output of the first node.

In some aspects, the neural network may be configured to generate an inference based on processing the output of the first node and the output of the second node. The neural network may further be configured to output the generated inference. In some aspects, the generated inference may be output to one or more other processing units within the node, such that one or more actions may be taken based on the generated inference. For example, these actions may include generating one or more control inputs to control the velocity, acceleration, and/or direction of travel of an autonomous vehicle, identifying objects in captured imagery, or other actions which may be triggered based on inferences generated by a neural network.

In some aspects, a first portion of the neural network is executed on the node, and wherein other portions of the neural network are executed on nodes of the plurality of nodes other than the node. For example, the first portion of the neural network may be a first layer in the neural network, and other portions may correspond to other layers in the neural network.

FIG. 5 illustrates example operations 500 for training a neural network to generate inferences based on sparse data in a distributed inference scheme, according to embodiments of the present disclosure. Operations 500 may be performed, for example, by a computing system, such as a cloud compute instance, a distributed computing system, or other computer or group of computers which can train a neural network and deploy the trained neural network to nodes that can participate in a distributed inference scheme.

As illustrated, operations 500 begin at block 510, with training a neural network including a plurality of layers. The neural network may include, for example, a convolutional neural network, a transformer neural network, or other neural networks which can be distributed across different nodes participating in the distributed inference scheme.

At block 520, operations 500 proceed with generating a respective weight mask matrix for each respective layer of the plurality of layers in the neural network based on a number of input features and a number of output features in the respective layer and calculated vector norms for non-diagonal rows in the respective weight mask matrix.

In some aspects, generating the respective weight mask matrix for the respective layer includes identifying the non-diagonal rows in the respective weight mask matrix as rows having a size based on a number of output features and a number of nodes in the neural network and corresponding to a set of weights in the neural network defined based on the number of output features, a kernel size, and the number of nodes. A sum is calculated for each non-diagonal row of the identified non-diagonal rows. Values in the weight mask matrix are set to 0 for non-diagonal rows in the identified non-diagonal rows having calculated sums less than a threshold value.

In some aspects, a number of features pruned by setting a corresponding element in the respective weight mask matrix to 0 is associated with a defined communication sparsity for the respective layer of the plurality of layers in the neural network. Generally, the number of features pruned from the set of features may have a direct relationship to the level of communication sparsity defined for the neural network. That is, smaller numbers of features may be pruned as the level of communication sparsity decreases, and larger numbers of features may be pruned as the level of communication sparsity increases.

In some aspects, the respective weight mask matrix identifies features transferred from a first layer in the neural network to a second layer in the neural network, and wherein the features identified in the respective weight mask matrix comprise a subset of candidate features transferrable between the first layer in the neural network and the second layer in the neural network.

At block 530, operations 500 proceed with deploying the neural network and the respective weight mask matrix for each respective layer of the plurality of layers.

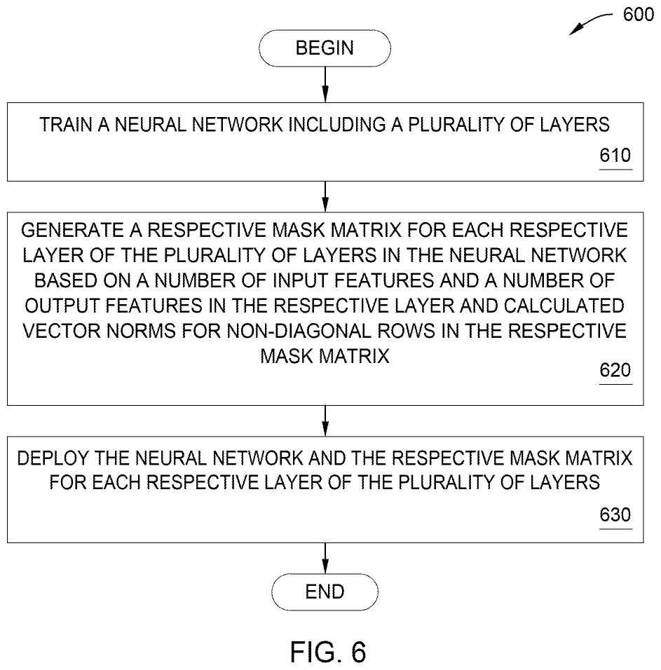

FIG. 6 illustrates an example system 600 configured to perform the methods described herein, including, for example, operations 400 of FIG. 4. In some embodiments, system 600 may be a node participating in a distributed inference scheme and deployed in an environment such that system 600 captures incomplete data about the environment which is augmented by data captured by other nodes participating in the distributed inference scheme.

As shown, system 600 includes a central processing unit (CPU) 602, one or more I/O device interfaces 604 that may allow for the connection of various I/O devices 614 to the system 600, network interface 606 through which system 600 is connected to network 690 (which may be a local network, an intranet, the internet, or any other group of computing devices communicatively connected to each other), a memory 608, storage 610, and an interconnect 612. The I/O devices 614 and/or network interface 606 may be used to receive a query in a natural language utterance through a chatbot application and output a response to the query generated based on extracting operators and operands from the natural language utterance.

CPU 602 may retrieve and execute programming instructions stored in the memory 608. Similarly, the CPU 602 may retrieve and store application data residing in the memory 608. The interconnect 612 transmits programming instructions and application data, among the CPU 602, I/O device interface 604, network interface 606, and memory 608.

CPU 602 is included to be representative of a single CPU, multiple CPUs, a single CPU having multiple processing cores, and the like.

Memory 608 is representative of a volatile memory, such as a random access memory, or a nonvolatile memory, such as nonvolatile random access memory, phase change random access memory, or the like. As shown, memory 608 includes a sparsified input generator 620, input combiner 630, and neural network 640.

Sparsified input generator 620 generally uses a weight matrix associated with the neural network 640 to identify input features captured by system 600 (or sensors or other devices connected thereto) which are to be communicated to other systems participating in the distributed inference scheme and to identify input features which are not to be communicated to other systems participating in the distributed inference scheme. Generally, the weight matrix includes zero-valued weights for features that are to not to be transmitted to other participating systems in the distributed inference scheme and non-zero-valued weights for features that are to be transmitted to other participating systems in the distributed inference scheme. The identified features may be transmitted to the other participating systems in the distributed inference scheme such that a number of input features smaller than the total number of captured input features are communicated to the other participating systems.

Input combiner 630 generates a combined input based on the input features generated based on data captured or otherwise ingested by system 600 and sparsified inputs received from other participating systems in the distributed inference scheme. Input combiner 630 provides the combined input to neural network 640 for processing. The output generated by neural network 640 may be provided as input into another neural network or another portion (e.g., layer) of the same neural network and/or may be used to trigger execution of various actions based on an inference generated for the input data by neural network 640.

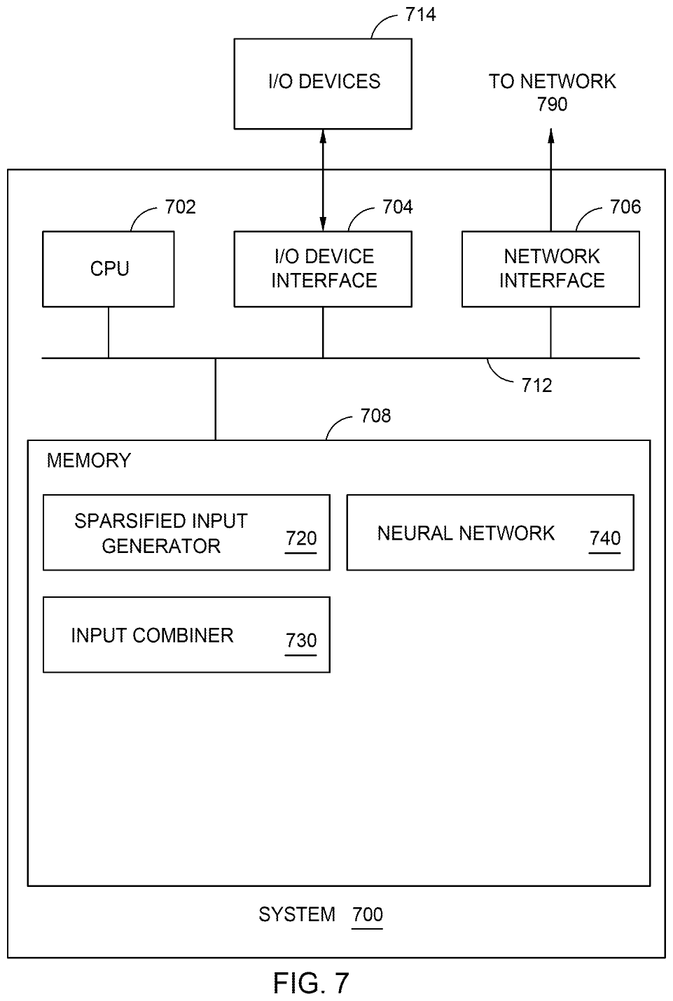

FIG. 7 illustrates an example system 700 configured to perform the methods described herein, including, for example, operations 500 of FIG. 5.

As shown, system 700 includes a central processing unit (CPU) 702, one or more I/O device interfaces 704 that may allow for the connection of various I/O devices 714 to the system 700, network interface 706 through which system 700 is connected to network 790 (which may be a local network, an intranet, the internet, or any other group of computing devices communicatively connected to each other), a memory 708, storage 710, and an interconnect 712. The I/O devices 714 and/or network interface 707 may be used to receive a query in a natural language utterance through a chatbot application and output a response to the query generated based on extracting operators and operands from the natural language utterance.

CPU 702 may retrieve and execute programming instructions stored in the memory 708. Similarly, the CPU 702 may retrieve and store application data residing in the memory 708. The interconnect 712 transmits programming instructions and application data, among the CPU 702, I/O device interface 704, network interface 706, and memory 708.

CPU 702 is included to be representative of a single CPU, multiple CPUs, a single CPU having multiple processing cores, and the like.

Memory 708 is representative of a volatile memory, such as a random access memory, or a nonvolatile memory, such as nonvolatile random access memory, phase change random access memory, or the like. As shown, memory 708 includes a neural network trainer 720, a mask matrix generator 730, and neural network deployer 740.

Generally, neural network trainer 720 trains a neural network including a plurality of layers. The neural network may be, for example, a convolutional neural network, a transformer neural network, or other network for which execution may be distributed across multiple nodes (e.g., multiple instances of system 600 illustrated in FIG. 6). Generally, the trained neural network may be defined, at least in part, as a series of weights applied to each of a plurality of inputs based on which an output (or inference) is generated.

Mask matrix generator 730 generally uses the weight information generated by neural network trainer 720 to generate a weight mask matrix identifying inputs that need not be shared by different participants in a distributed inference scheme. Generally, the weight mask matrix may be generated as a weight pruning scheme in which a statistical norm over different subsets of weights are used to identify features which are pertinent to computations performed at a given node and features which are less pertinent to computations performed at a given node. Masked weights (e.g., zero-valued weights in the mask matrix) may correspond to features that are less pertinent to computations performed at a given node, while unmasked weights (e.g., non-zero-valued weights in the mask matrix) may correspond to features that are pertinent to computations performed at a given node.

Neural network deployer 740 deploys the trained neural network and the generated mask matrices associated with the trained neural network to nodes which can participate in a distributed inference scheme.

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A system for a distributed inferencing scheme, comprising:
a memory having executable instructions stored thereon; and
a processor configured to execute the executable instructions in order to cause to a first node in the distributed inferencing scheme to:
receive an input for processing by a neural network executing on a plurality of nodes participating in the distributed inference scheme;
generate, for a second node of the plurality of nodes, a first sparsified input based on a set of features associated with the second node, wherein:
the set of features associated with the second node are identified based on a weight mask having non-zero values associated with weights for features upon which processing by the second node depends and zeroed values associated with weights for features other than the features upon which processing by the second node depends,
the weight mask comprises a mask having been generated based on calculated vector norms for non-diagonal rows in the weight mask, including a number of non-zero weights defined based on a number of output features, a kernel size, and a number of nodes defined for the neural network, and
the set of features comprises a subset of features derived from the received input;
transmit the first sparsified input to the second node for generating an output of the second node;
receive a second sparsified input from the second node;
combine the received input and the second sparsified input into a combined input; and
process the combined input into an output of the first node,
wherein the neural network is configured to generate an inference based on processing at least the output of the first node and the output of the second node and output the generated inference.

2. The node of claim 1, wherein the set of features associated with the second node of the plurality of nodes is selected further based on a level of communication sparsity defined for the neural network.

3. The node of claim 1, wherein the weight mask comprises a two-dimensional matrix including information identifying weights for each kernel of a plurality of kernels in the neural network, wherein kernels associated with the features upon which processing by the second node depends are associated with non-zero values in the two-dimensional matrix and kernels associated with features other than the features upon which processing by the second node depends are associated with zeroed values in the two-dimensional matrix.

4. The node of claim 3, wherein diagonal blocks in the two-dimensional matrix comprise non-zero values associated with features used by the neural network for inputs associated with the node.

5. The node of claim 1, wherein a number of features associated with the second node is based, at least in part, on a number of nodes participating in the distributed inference scheme.

6. The node of claim 1, wherein the set of features associated with the second node of the plurality of nodes comprises features having a statistical norm that is less than a threshold value.

7. The node of claim 1, wherein the processor is further configured to cause the node to take one or more actions based on the generated inference.

8. The node of claim 1, wherein the neural network comprises a convolutional neural network, and the input comprises a feature map representing data to be processed using the convolutional neural network.

9. The node of claim 1, wherein the neural network comprises a transformer neural network, and the input comprises one or more neuron vectors representing data to be processed using the transformer neural network.

10. The node of claim 1, wherein a first portion of the neural network is executed on the node, and wherein other portions of the neural network are executed on nodes of the plurality of nodes other than the node.

11. A processor-implemented method by a node participating in a distributed inferencing scheme, comprising:
receiving an input for processing by a neural network executing on a plurality of nodes participating in the distributed inference scheme,
generating, for a second node of the plurality of nodes, a first sparsified input based on a set of features associated with the second node, wherein:
the set of features associated with the second node are identified based on a weight mask having non-zero values for weights associated with features upon which processing by the second node depends and zeroed values for weights associated with features other than the features upon which processing by the second node depends,
the weight mask comprises a mask having been generated based on calculated vector norms for non-diagonal rows in the weight mask, including a number of non-zero weights defined based on a number of output features, a kernel size, and a number of nodes defined for the neural network, and
the set of features comprises a subset of features derived from the received input;
transmitting the first sparsified input to the second node for generating an output of the second node;
receiving a second sparsified input from the second node;
combining the received input and the second sparsified input into a combined input; and
processing the combined input into an output of the first node;
wherein the neural network is configured to generate an inference based on processing the output of the first node and the output of the second node and output the generated inference.

12. The method of claim 11, wherein the set of features associated with the second node of the plurality of nodes is selected further based on a level of communication sparsity defined for the neural network.

13. The method of claim 11, wherein the weight mask comprises a two-dimensional matrix including information identifying weights for each kernel of a plurality of kernels in the neural network, wherein kernels associated with the features upon which processing by the second node depends are associated with non-zero values in the two-dimensional matrix and kernels associated with features other than the features upon which processing by the second node depends are associated with zeroed values in the two-dimensional matrix.

14. The method of claim 13, wherein diagonal blocks in the two-dimensional matrix comprise non-zero values associated with features used by the neural network for inputs associated with the node.

15. The method of claim 11, wherein a number of features associated with the second node is based, at least in part, on a number of nodes participating in the distributed inference scheme.

16. The method of claim 11, wherein the set of features associated with the second node of the plurality of nodes comprises features having a statistical norm that is less than a threshold value.

17. The method of claim 11, further comprising taking one or more actions based on the generated inference.

18. The method of claim 11, wherein the neural network comprises a convolutional neural network, and the input comprises a feature map representing data to be processed using the convolutional neural network.

19. The method of claim 11, wherein the neural network comprises a transformer neural network, and the input comprises one or more neuron vectors representing data to be processed using the transformer neural network.

20. The method of claim 11, wherein a first portion of the neural network is executed on the node, and wherein other portions of the neural network are executed on nodes of the plurality of nodes other than the node.

21. A processor-implemented method for training a neural network for a distributed inference scheme, comprising:
training a neural network including a plurality of layers;
generating a respective weight mask matrix for each respective layer of the plurality of layers in the neural network based on a number of input features and a number of output features in the respective layer and calculated vector norms for non-diagonal rows in the respective weight mask matrix; and
deploying the neural network and the respective weight mask matrix for each respective layer of the plurality of layers.

22. The method of claim 21, wherein generating the respective weight mask matrix for the respective layer of the plurality of layers in the neural network comprises:
identifying the non-diagonal rows in the respective mask matrix as rows having a size based on a number of output features and a number of nodes in the neural network and corresponding to a set of weights in the neural network defined based on the number of output features, a kernel size, and the number of nodes;
calculating a sum for each non-diagonal row of the identified non-diagonal rows; and
setting values in the mask matrix to 0 for non-diagonal rows in the identified non-diagonal rows having calculated sums less than a threshold value.

23. The method of claim 21, wherein a number of features pruned by setting a corresponding element in the respective mask matrix to 0 is associated with a defined communication sparsity for the respective layer of the plurality of layers in the neural network.

24. The method of claim 21, wherein the respective mask matrix identifies features transferred from a first layer in the neural network to a second layer in the neural network, and wherein the features identified in the respective mask matrix comprise a subset of candidate features transferrable between the first layer in the neural network and the second layer in the neural network.
